(19) United States
(12) Patent Application Publication
(10) Pub. No.: US 2007/0251370 A1
(43) Pub. Date: Nov. 1, 2007

(54) Fixture structure of cutting machine tool

(75) Inventor: Pan-Chung Hsieh, Tou-Liu City (TW)

Correspondence Address: TROXELL LAW OFFICE PLLC, SUITE 1404, 5205 LEESBURG PIKE, FALLS CHURCH, VA, 22041, US

(73) Assignee: Lee Yeong Industrial Co., Ltd.

(21) Appl. No.: 11/414,199

(22) Filed: May 1, 2006

(51) Int. Cl. B23D 45/16

(52) U.S. Cl. 83/745; 83/574; 30/388

(57) ABSTRACT

An improved fixture structure of cutting machine tool being simple in structure and capable of operating the machine tool in stable condition includes a cutting machine tool, a base plate being disposing at the bottom of the cutting machine tool forming at least a salient rib, a fixture device, and a magnet contained in the fixture device. The fixture device has at least a guided rail providing at a side thereof for containing the salient rib of the base plate and providing motion within the guided rail. The cutting machine tool can perform stable motion to execute cutting operation along the fixture device adhered on the ferrite material.

### BACKGROUND OF THE INVENTION

1. Field of the Invention

The invention relates to an improved fixture structure of cutting machine tool, and more particularly, to an improved fixture structure of cutting machine tool that being simple in structure is capable of making the machine tool smoothly perform direct cutting by following the required dimensions and predetermined lines.

2. Description of the Prior Art

The commonly seen cutting machine tools, such as the series of portable band saw and circular saw and the series of stationary type of band saw and circular saw, being designed to be small type and light in weight, include only a tool, a power transmission mechanism, a positioning adjustment device, and a pressing holding portion for being convenient in carrying along. In general, the fact that the stationary type of cutting machine tool having relatively heavier body and accessories makes the cutting machine tool capable of performing stable operation by following a predetermined dimension and path to cut the ferrite material. Although the portable cutting machine tool certainly can lessen the trouble of carrying it along, practically it is unable to achieve stable effect when it comes to cutting operation as comparing with the stationary type of cutting machine tool. The reason is that for stationary type cutting machine tool, the reaction generated by the cutting action toward the ferrite material can be absorbed by the weight of the body of the cutting machine tool itself while for the portable cutting machine tool, it all depends on the operator to exert holding force for resisting the reaction. Consequently, when it comes to cutting the ferrite material by the use of portable cutting machine tool, the portable cutting machine tool (10) is apt to generate a non-predetermined shape or path of cutting operation. As a result, the ferrite material, after finishing the cutting operation, needs to perform another finishing operation. Thereby it is not only waste of time but also waste of material. In addition, it is also because of the unstable condition in cutting operation by the use the portable cutting machine tool, the operator is subject to get hurt.

For the sake of improving the above-mentioned demerits, researchers in the relevant enterprise provide a base plate and a working pan for auxiliary and securing purpose. Both the base plate and the working pan have indented and salient rails making the base plate capable of disposing at the working pan to form a guided rail or a sliding path letting the cutting machine tool capable of undertaking reciprocating motion on the working pan. A plurality of skid-resistant strips are equipped on the bottom surface of the base plate for providing frictional force that makes the working pan capable of adhering on the ferrite material.

However, it is known for those persons skilled in the art that the above-mentioned improved structure for the cutting machine tool will still occur jumping action while its is performing cutting operation resulting undesirable cutting lines that are not what we expected.

Another issue relevant to this kind of cutting machine tool is that when it comes to performing cutting operation at an inclined angle, practically it is capable of performing cutting in inclined angle by operating the cutting machine tool. In general, the cutting lines at this moment will form quite a large offset from the datum position of the cutting line when the cutting line is in perpendicular position. This condition will cause trouble for the operators on calibrating when they are setting the position of the cutting line and will result in the inconvenience when the cutting machine tool is performing inclined cutting operation.

### SUMMARY OF THE INVENTION

In light of the above-mentioned disadvantages of the prior arts, the invention aims to ameliorate at least some of the disadvantages of the prior art or to provide a useful alternative.

The primary objective of the invention is to provide an improved fixture structure of cutting machine tool. The improved fixture structure of cutting machine tool being simple in structure and capable of operating the machine tool in stable condition includes a cutting machine tool, a base plate being disposing at the bottom of the cutting machine tool forming at least a salient rib, a fixture device, and a magnet contained in the fixture device. The fixture device has at least a guided rail providing at a side thereof for containing the salient rib of the base plate and providing free motion within the guided rail. The cutting machine tool can perform stable motion to execute cutting operation along the fixture device adhered on the ferrite material.

The accomplishment of this and other objectives of the invention will become apparent from the following description and its accompanying drawings of which:

### BRIEF DESCRIPTION OF THE DRAWINGS

FIG. 1 is a schematic and isometric view of the invention;

FIG. 2 is a schematic and cross-sectional view of the invention;

FIG. 3 is a schematic and isometric view of a preferred embodiment the invention;

FIG. 4 is a schematic, fragmentary cross-sectional, front elevation view of FIG. 3 of the invention;

FIG. 5 is a schematic, rear elevation view of a feasible embodiment of the invention;

FIG. 6 is a schematic, cross-sectional view of another feasible embodiment of the invention;

FIG. 7 is a schematic, fragmentary cross-sectional view of another feasible embodiment of the invention.

### DETAILED DESCRIPTION OF THE PREFERRED EMBODIMENT

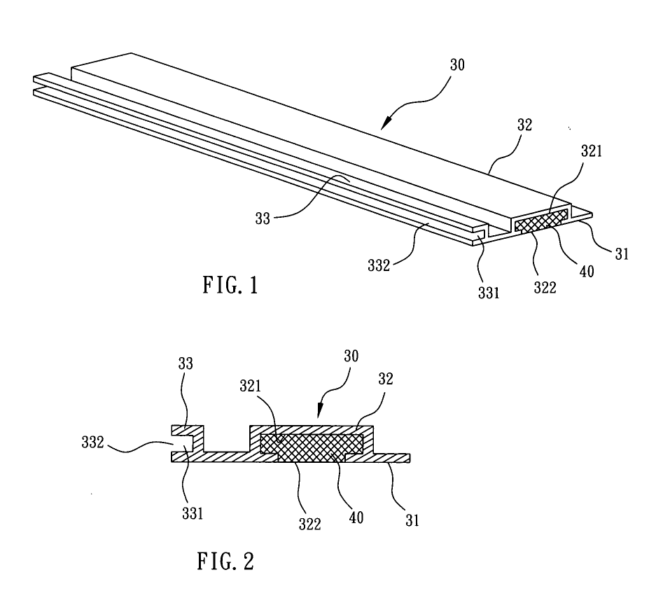

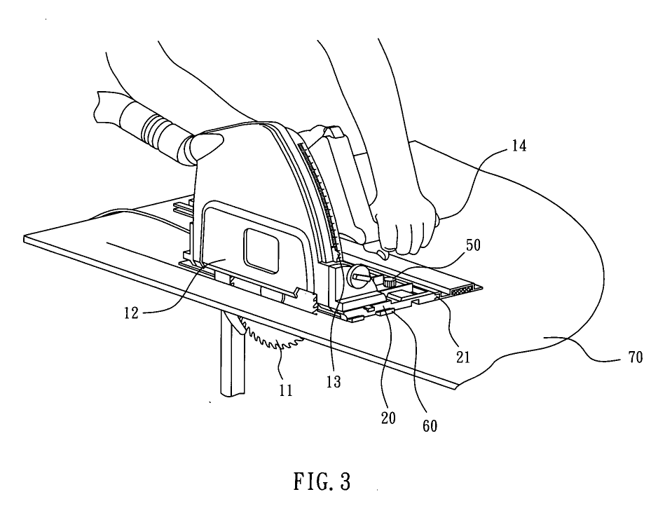

FIG. 1 is a schematic and isometric view of the invention, FIG. 2 is a schematic and cross-sectional view of the invention, while FIG. 3 is a schematic and isometric view of a preferred embodiment the invention. As shown in FIG. 1, 2, and 3, the improved fixture structure of cutting machine tool in the adopted embodiment of the invention includes a cutting machine tool (10), a base plate (20), a fixture device (30), and a magnet (40).

The cutting machine tool (10) includes a tool (11), a power transmission mechanism (12), a positioning adjustment device (13), and a pressing holding portion (14); wherein the tool (11) is connected to the power transmission mechanism (12) and the pressing holding portion (14) forming a function of interlocking motion. The pressing holding portion (14) being interconnected to the positioning adjustment device (13) is for limiting both the pressing holding portion (14) and the tool (11) to perform motion within the range of a fixed angle when the positioning adjustment device (13) is set in a predetermined angle. The base plate (20) being a rectangular plank in shape includes a salient rib (21) formed at a side thereof.

In a preferred embodiment of the invention, the fixture device (30) being a rectangular plank in shape includes a horizontal bottom surface (31), a salient portion (32) extending upward along the bottom surface (31), and a guided rail (33) formed on the bottom surface (31). The salient portion (32) has a containing space (321) for containing the magnet (40), and an opening (322) open toward the bottom surface (31) to facilitate the magnet (40) directly contacting and adhering to the ferrite material (70). In a embodiment adopted by the invention, the guided rail (33) is a C-shaped channel (331) to facilitate the opening (332) matching with the corresponding salient rib (21) at a side of the base plate (20). In this way, the cutting machine tool (10) and the base plate (20) can perform a reciprocating motion along the guided rail (33) of the fixture device (30).

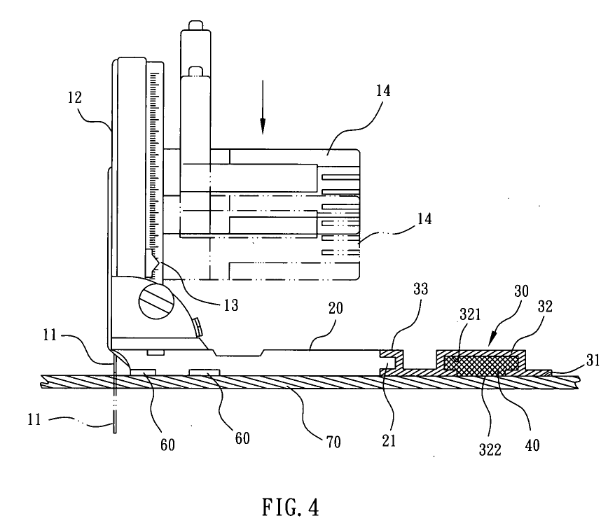

FIG. 3 is a schematic and isometric view of a preferred embodiment the invention while FIG. 4 is a schematic, fragmentary cross-sectional, front elevation view of FIG. 3 of the invention. As shown in FIG. 3 and FIG. 4, the fixture device (30), directly through the magnet (40), can secure at a pre-determined location on the ferrite material (70) and in the meantime, make the salient rib (21) match and fit into the C-shaped channel (331) thereof. When power in on for the power transmission mechanism (12) of the cutting machine tool (10), the tool (11) will rotate through the transmission. Accordingly, the operator needs only to hold the pressing holding portion (14) and perform action following the arrowhead direction as shown in FIG. 4 in order to drive the tool (11) moving downward to cut the ferrite material (70). Moreover, through the matching of the guided rail (33) of the fixture device (30) and the salient rib (21) of the cutting machine tool (10), the tool (11) will follow the predetermined cutting line to perform cutting operation while the cutting machine tool (10) move along the path of the guided rail (33).

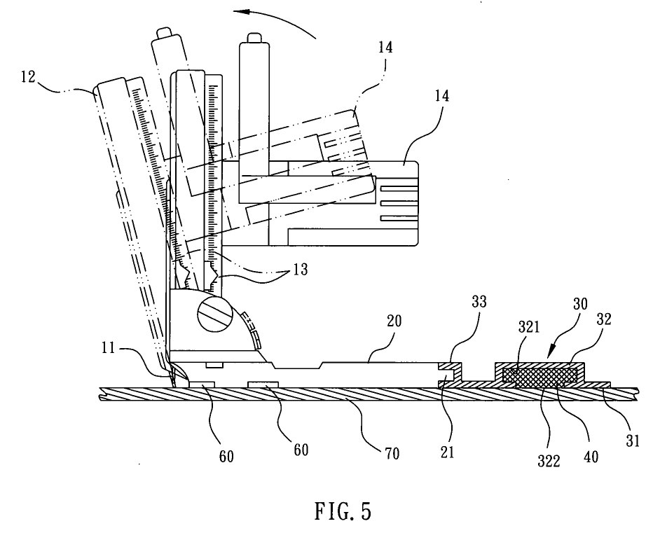

FIG. 5 is a schematic, rear elevation view of a feasible embodiment of the invention. As shown in FIG. 5, one can operate the cutting machine tool (10) in an inclined angle when the ferrite material (70) is precut at an inclined angle. In doing this, the cutting line of the inclined tool (11) will align with original predetermined cutting line without the need of performing any calibration like the prior art does.

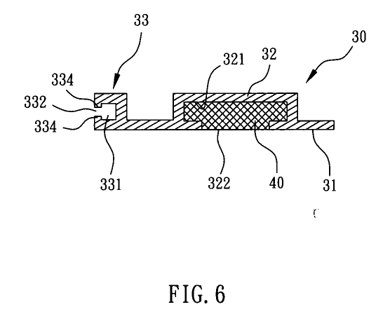

FIG. 6 is a schematic, cross-sectional view of another feasible embodiment of the invention. As shown in FIG. 6, each of the two ends of the channel (331) of the guided rail (33) of the fixture device (30) provides a bump (334) facing inward and extended in opposite position. While the salient rib (21) of the base plate (20) of the cutting machine tool (10) matches with the channel (331), these bumps (334) can enhance the secured stability of the cutting machine tool (10).

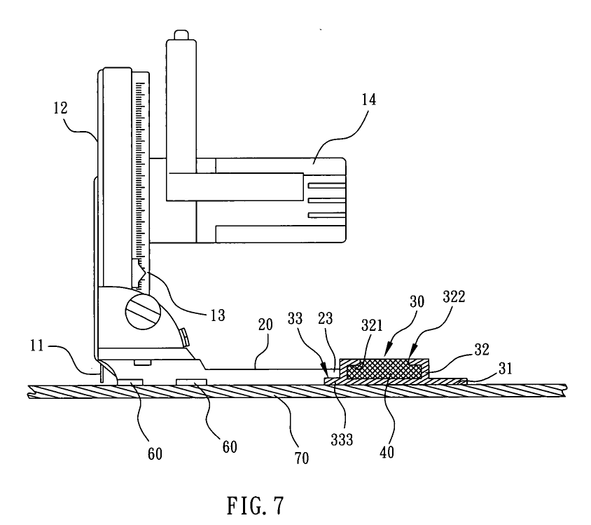

FIG. 7 is a schematic, fragmentary cross-sectional view of another feasible embodiment of the invention. As shown in FIG. 7, the fixture device (30) includes a horizontal bottom surface (31), a salient portion (32) having an opening (322) open in upward direction, and a guided rail (33). A plain pedestal (333) being formed by the guided rail (33) and having the same height as that of the bottom surface (31) makes a side of the base plate (20) of the cutting machine tool (10) form a L-shaped step (22) disposing in downward direction. This step (22) can combine with the corresponding pedestal (333) making the cutting machine tool (10) and the base plate (20) perform reciprocating motion along the guided rail (33) of the fixture device (30).

To sum up, the improved fixture structure of cutting machine tool (10) makes a good progress in the limited area of the technical development of the fixture device (30) of the cutting machine tool (10). This is because of the fact that it makes use of the association of the simple structure of fixture device (30), the base plate (20), and the magnet (40) to ameliorate the disadvantages of the fixture device of the cutting machine tool (10) of the prior art.

It will become apparent to those people skilled in the art that various modifications and variations can be made to the structure of the invention without departing from the scope or spirit of the invention. In view of the foregoing description, it is intended that all the modifications and variation fall within the scope of the following appended claims and their equivalents.

What is claimed is:

1. An improved fixture structure of cutting machine tool comprising a cutting machine tool, a base plate being disposing at the bottom of the cutting machine tool forming at least a salient rib, a fixture device, and a magnet contained in the fixture device; wherein the fixture device has at least a guided rail providing at a side thereof for containing the salient rib of the base plate and providing motion within the guided rail; and the cutting machine tool can perform stable motion to execute cutting operation along the fixture device adhering on the ferrite material.

2. The improved fixture structure of cutting machine tool as claimed in claim 1, wherein the cutting machine tool further includes a tool, a power transmission mechanism, a positioning adjustment device, and a pressing holding portion wherein the tool is connected to the power transmission mechanism and the pressing holding portion while the pressing holding portion is connected to the positioning adjustment device.

3. The improved fixture structure of cutting machine tool as claimed in claim 1, wherein the base plate being a rectangular plank in shape includes a salient rib formed at a side thereof.

4. The improved fixture structure of cutting machine tool as claimed in claim 1, wherein the fixture device being a rectangular plank in shape includes a horizontal bottom surface, a salient portion extending upward along the bottom surface, and a guided rail formed on the bottom surface.

5. The improved fixture structure of cutting machine tool as claimed in claim 4, wherein the salient portion has a containing space for containing the magnet, and an opening open toward the bottom surface.

6. The improved fixture structure of cutting machine tool as claimed in claim 4, wherein the guided rail is a C-shaped channel.

7. The improved fixture structure of cutting machine tool as claimed in claim 6, wherein each of the two ends of the channel of the guided rail further comprises a bump facing inward and extended in opposite position.

8. The improved fixture structure of cutting machine tool as claimed in claim 4, wherein the salient portion has an opening open in upward direction.

9. The improved fixture structure of cutting machine tool as claimed in claim 4, wherein the guided rail forms a plain pedestal that has the same height as that of the bottom surface.

10. The improved fixture structure of cutting machine tool as claimed in claim 3, wherein a side of the base plate forms a L-shaped step disposing in downward direction.

11. The improved fixture structure of cutting machine tool as claimed in claim 1, wherein the guided rail is a C-shaped channel.

12. The improved fixture structure of cutting machine tool as claimed in claim 11, wherein each of the two ends of the channel of the guided rail further comprises a bump facing inward and extended in opposite position.

13. The improved fixture structure of cutting machine tool as claimed in claim 1, wherein the salient portion has an opening open in upward direction.

14. The improved fixture structure of cutting machine tool as claimed in claim 1, wherein the guided rail forms a plain pedestal that has the same height as that of the bottom surface.

15. The improved fixture structure of cutting machine tool as claimed in claim 1, wherein a side of the base plate forms a L-shaped step disposing in downward direction.
